(19) United States
(12) Patent Application Publication
(10) Pub. No.: US 2019/0085870 A1
(43) Pub. Date: Mar. 21, 2019

(54) ELECTRO-HYDRAULIC SERVO VALVE WITH COIL-TYPE FEEDBACK SPRING

(71) Applicant: HONEYWELL INTERNATIONAL INC., Morris Plains, NJ (US)

(72) Inventors: Jing Wang, Shanghai (CN); Larry Portolese, Granger, IN (US); Jason Dai, Shanghai (CN); Daniel Laboda, Niles, MI (US)

(73) Assignee: HONEYWELL INTERNATIONAL INC., Morris Plains, NJ (US)

(21) Appl. No.: 15/705,714

(22) Filed: Sep. 15, 2017

(51) Int. Cl. F15B 13/044; F15B 13/04; F15B 13/043; F15B 13/16

(52) U.S. Cl. CPC F15B 13/0444; F15B 13/16; F15B 13/0438; F15B 13/0402

(57) ABSTRACT

An electrohydraulic servo valve (EHSV) includes a housing assembly, a spool valve, an armature, a control mechanism, and a feedback spring. The spool valve is movably disposed within the housing assembly. The armature is rotationally mounted on the housing assembly. The control mechanism is coupled to the armature and is rotatable therewith. The feedback spring is coupled between the control mechanism and the spool valve, and includes a helical coil that is disposed on and engages the control mechanism, and a cantilever portion that extends from the helical portion to a terminus that engages the spool valve.

### TECHNICAL FIELD

The present invention generally relates to electro-hydraulic servo valves (EHSVs), and more particularly relates to an EHSV with a coil-type feedback spring.

### BACKGROUND

Electro-hydraulic servo valves (EHSVs) are used in numerous and varied systems. As is generally known, an EHSV is an electrically operated hydraulic servo valve that controls how hydraulic fluid is ported to an actuator. Servo valves are operated by transforming a changing analogue or digital input signal into a smooth set of movements in a hydraulic cylinder. Servo valves can provide precise control of position, velocity, pressure and force with good post movement damping characteristics.

A typical EHSV includes torque motor, a control mechanism, and a spool valve. The torque motor is responsive to an applied current to rotate to a position. The control mechanism, which is most commonly either a flapper or jet tube, is coupled to, and thus rotates with the torque motor. The position of the control mechanism impacts the differential pressure across the spool valve, causing it to move, which may in turn impact hydraulic fluid pressure across another device, such as, for example, a hydraulic actuator.

Many EHSVs also include a feedback spring. The feedback spring, when included, is coupled between the control mechanism and the valve, and provides a stabilizing force to the control mechanism and provides closed-loop mechanical feedback between the spool valve and first-stage torque motor. The feedback spring is typically a cantilever-type spring with a spherical ball coupled to the end. The ball is disposed within a cavity or socket formed in the spool valve.

Feedback springs are often composed of multiple parts that are attached together via brazing or soldering, which can lead to high part-to-part variability, and increased cost for the subassembly. Additionally, joining the feedback spring subassembly onto the control mechanism requires special processes, further adding to the assembly time and associated cost.

Hence, there is a need for an EHSV that includes a feedback spring that is simple in design and construction, as compared to known feedback springs, and that can be attached to the control mechanism quickly and without special processes, resulting in reduced part costs and assembly time. Additionally, the feedback spring must be durable to withstand operational and vibration loads, and must display a consistent and linear spring rate. The present invention addresses at least these needs.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, an electrohydraulic servo valve (EHSV) includes a housing assembly, a spool valve, an armature, a control mechanism, and a feedback spring. The spool valve is movably disposed within the housing assembly. The armature is rotationally mounted on the housing assembly. The control mechanism is coupled to the armature and is rotatable therewith. The feedback spring is coupled between the control mechanism and the spool valve, and includes a helical coil that is disposed on and engages the control mechanism, and a cantilever portion that extends from the helical portion to a terminus that engages the spool valve.

In another embodiment, an electrohydraulic servo valve (EHSV) includes a housing assembly, a spool valve, an armature, a jet tube, and a feedback spring. The spool valve is movably disposed within the housing assembly. The armature is rotationally mounted on the housing assembly. The jet tube is coupled to the armature and is rotatable therewith. The feedback spring is coupled between the jet tube and the spool valve, and includes a helical coil that is disposed on and engages the jet tube, and a cantilever portion that extends from the helical portion to a terminus that engages the spool valve.

In yet another embodiment, an electrohydraulic servo valve (EHSV) includes a housing assembly, a spool valve, an armature, a flapper, and a feedback spring. The spool valve is movably disposed within the housing assembly. The armature is rotationally mounted on the housing assembly. The flapper is coupled to the armature and is rotatable therewith. The feedback spring is coupled between the flapper and the spool valve, and includes a helical coil that is disposed on and engages the flapper, and a cantilever portion that extends from the helical portion to a terminus that engages the spool valve.

Furthermore, other desirable features and characteristics of the EHSV with the coil-type feedback spring will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a simplified schematic representation of one embodiment of an electrohydraulic servo valve (EHSV);

FIG. 2 depicts a simplified schematic representation of another embodiment of an EHSV;

FIG. 3 depicts a plan view of one embodiment of a feedback spring that may be used in the EHSVs of FIGS. 1 and 2;

FIG. 4 depicts the feedback spring of FIG. 3 disposed on a control mechanism of the EHSV of either of FIGS. 1 and 2;

FIG. 5 depicts the feedback spring disposed on a control mechanism that has a machined recess;

FIG. 6 depicts a feedback spring and control mechanism similar to FIG. 5, but with a cavity engagement feature disposed thereon;

FIG. 7 depicts an arrangement for securing the cavity engagement feature; and

FIGS. 8 and 9 depict alternative embodiments of cavity engagement features.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

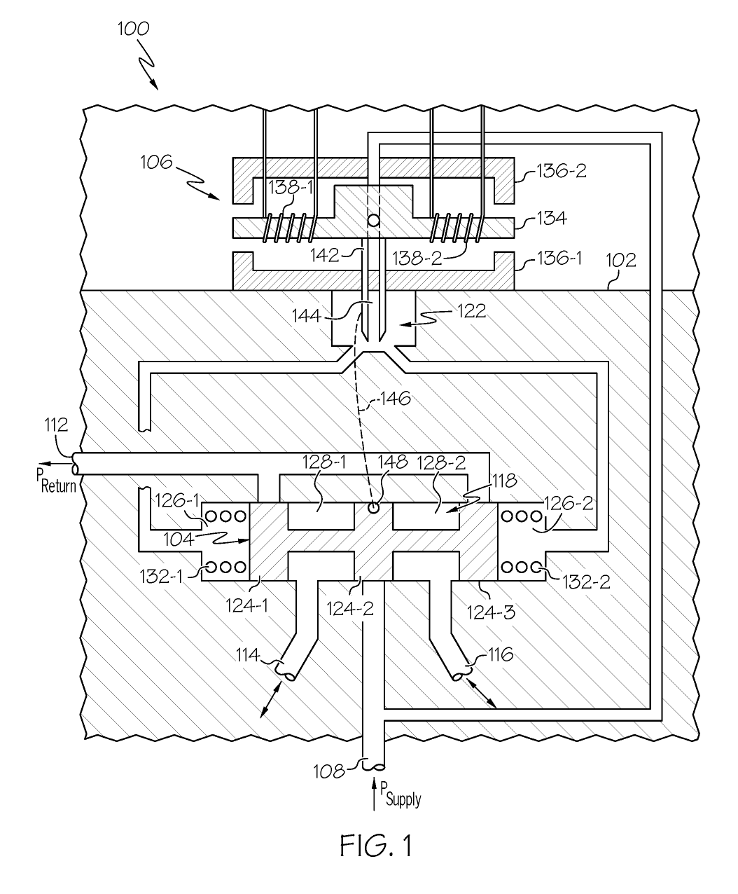

Referring to FIG. 1, a simplified schematic representation of one embodiment of an electrohydraulic servo valve (EHSV) 100 is depicted, and includes a housing assembly 102, a spool valve 104, and a torque motor 106. The housing assembly 102 includes a supply port 108, a return port 112, a first actuator port 114, a second actuator port 116, a spool valve cavity 118, and a control mechanism cavity 122. The supply port 108 is configured to be coupled to, and receive hydraulic fluid from, a non-illustrated hydraulic fluid pressure source, and is in fluid communication, via one or more internal flow channels, with both the spool valve cavity 118 and the control mechanism cavity 122. The return port 112 is configured to be coupled to, and return hydraulic fluid to, a non-illustrated hydraulic fluid pressure sink. The return port 112 is also in fluid communication, via one or more internal flow channels, with the spool valve cavity 118. The first and second actuator ports 114, 116 are in fluid communication with the spool cavity 118 and are configured to be coupled to a non-illustrated device, such as a hydraulic actuator.

The spool valve 104 is movably disposed within the housing assembly 102, and more specifically within the spool cavity 118. Although the spool valve 104 may be variously configured, in the depicted embodiment it includes three interconnected pistons 124 (124-1, 124-2, 124-3) that divide the spool cavity 118 into four chambers—a first control pressure chamber 126-1, a second control pressure chamber 126-2, a first actuator control chamber 128-1, and a second actuator control chamber 128-2. The first and second control pressure chambers 126-1, 126-2 are in fluid communication with the control mechanism cavity 122. The first actuator control chamber 128-1 is in fluid communication with the first actuator port 114, and the second actuator control chamber 128-2 is in fluid communication with the second actuator port 116. In the depicted embodiment, two centering springs—a first centering spring 132-1 and a second centering spring 132-2—are disposed within the first and second actuator control chambers 126-1, 126-2, respectively, and are used to bias the spool valve 104 to the neutral position, which is the position depicted in FIG. 1. It will be appreciated that in some embodiments, the EHSV may be implemented without the centering springs 132.

The torque motor 106 is mounted on the housing assembly 102 and includes an armature 134, a pair of permanent magnets 136 (136-1, 136-2), and two coils 183 (138-1, 138-2). The armature 134 is rotationally mounted on the housing assembly 102, and the coils 138 are wrapped around opposing portions of the armature 134. A control mechanism 142 is coupled to, and is rotatable with, the armature 134. When current is supplied to the coils 138, a magnetic field is generated, which interacts with the magnetic fields of the permanent magnets 136, generating a torque. The torque, which is dependent on the magnitude and direction of the currents in the coils 138, causes the armature 104, and thus the control mechanism 142, to rotate.

The control mechanism 142 in the depicted embodiment is a jet tube that extends into the control mechanism cavity 122. A control pressure passage 144 extends through the jet tube 142, and provides fluid communication between the supply pressure port 108 and the control mechanism cavity 122. As is generally known, when the jet tube 142 is in the neutral, or center, position, which is the position depicted in FIG. 1, the fluid pressure in the first and second control pressure chambers 126-1, 126-2 is equal, and the spool valve 104 is in its neutral, or center, position. When the armature 134, and thus the jet tube 142, is rotated, this will cause the fluid pressure in one of the control pressure chambers 126-1 or 126-2 to increase, and the fluid pressure in the other control pressure chamber 126-2 or 126-1 to decrease. This, in turn, will cause the spool valve 104 to move to the right or left. If the spool valve 104 moves to the right, the first actuator control chamber 128-1 and first actuator port 114 are placed in fluid communication with the supply port 108, and the second actuator control chamber 128-2 and second actuator port 116 are placed in fluid communication with the return port 112. If the spool valve 104 moves to the left, the first actuator control chamber 128-1 and first actuator port 114 are placed in fluid communication with the return port 112, and the second actuator control chamber 128-2 and second actuator port 116 are placed in fluid communication with the supply port 108.

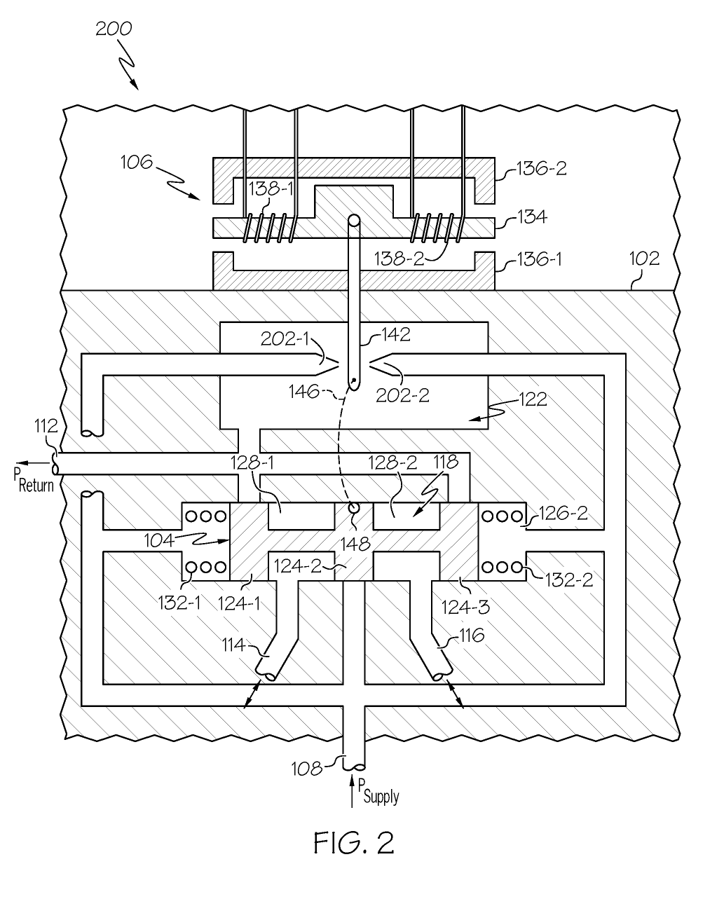

It will be appreciated that in other embodiments, the control mechanism 142 may be implemented using a flapper. One embodiment of an EHSV 200 that is implemented with a flapper 142 is depicted in FIG. 2. The EHSV 200 depicted in FIG. 2 is configured very similar to the EHSV 100 of FIG. 1. Indeed, like reference numerals in FIGS. 1 and 2 refer to like parts of the EHSVs 100 and 200. Beside using the flapper 142, some of the other differences with the EHSV 200 of FIG. 2 include two flapper nozzles 202—a first flapper nozzle 202-1 and a second flapper nozzle 202-2—that provide fluid communication between the supply pressure port 108 and the control mechanism cavity 122. Also, the first and second control pressure chambers 126-1, 126-2 are both in fluid communication with the supply pressure port 108, and each is in fluid communication with the control mechanism cavity 122 via a different flapper nozzle 202. Specifically, the first control pressure chamber 126-1 is in fluid communication with the control mechanism cavity 122 via the first flapper nozzle 202-1, and the second control pressure chamber 126-2 is in fluid communication with the control mechanism cavity 122 via the second flapper nozzle 202-2. In addition, the control mechanism cavity 122 is in continuous fluid communication with the return port 112.

With the EHSV 200 of FIG. 2, when the flapper 142 is in the neutral, or center, position, which is the position depicted in FIG. 2, the outlet flow areas of the flapper nozzles 202 are equal, and thus the fluid pressures in the first and second control pressure chambers 126-1, 126-2 are equal. As a result, the spool valve 104 is in its neutral, or center, position. When the armature 134, and thus the flapper 142, is rotated, this will cause the outlet flow area of one of the flapper nozzles 202-1 or 202-2 to increase, and the outlet flow area of the other flapper nozzle 202-2 or 202-1 to decrease. As a result, the fluid pressure in one of the control pressure chambers 126-1 or 126-2 will decrease, and the fluid pressure in the other control pressure chamber 126-2 or 126-1 will increase. This, in turn, will cause the spool valve 104 to move to the left or right. If the spool valve 104 moves to the left, the second actuator control chamber 128-2 and second actuator port 116 are placed in fluid communication with the supply port 108, and the first actuator control chamber 128-1 and first actuator port 114 are placed in fluid communication with the return port 112. If the spool valve 104 moves to the right, the first actuator control chamber 128-1 and first actuator port 114 are placed in fluid communication with the supply port 108, and the second actuator control chamber 128-2 and second actuator port 116 are placed in fluid communication with the return port 112.

Regardless of whether the control mechanism 142 is implemented using a jet tube or a flapper, and as FIGS. 1 and 2 both depict using dotted lines, the EHSV 100, 200 additionally includes a feedback spring 146. The feedback spring 146 is coupled between the control mechanism 142 and the spool valve 104 and functions, at least in part, to bias the control mechanism 142 toward the neutral position. The feedback spring 146 provides a stabilizing force to the control mechanism 142 and improves overall stability and response.

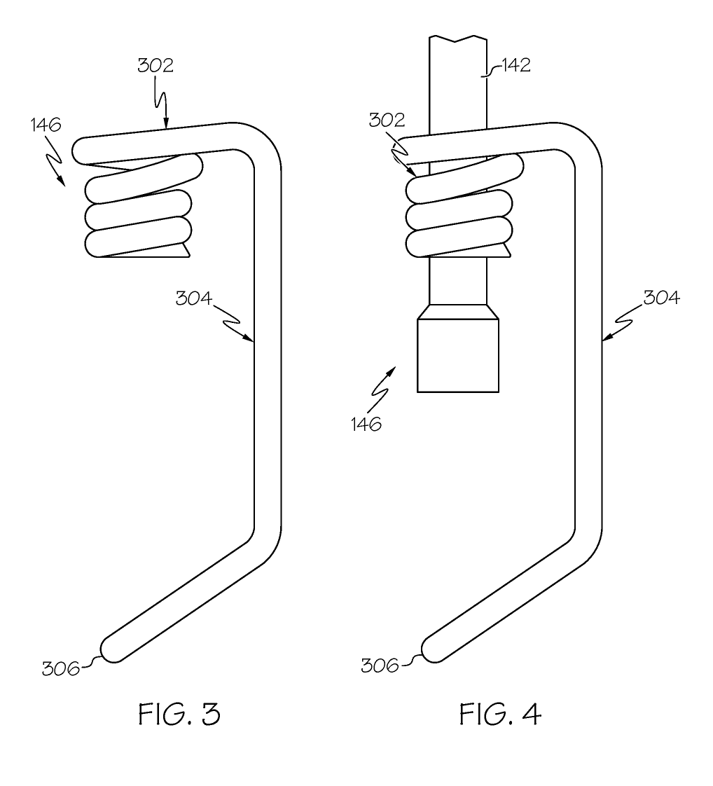

Although feedback springs 146 are not new, the configuration of the feedback spring used in the EHSV 100, 200 is new. In particular, the feedback spring 146, an embodiment of which is depicted in FIG. 3, includes a helical coil 302 and a cantilever portion 304. The helical portion 302, as depicted more clearly in FIG. 4, is disposed on and engages the control mechanism 142. As FIGS. 3 and 4 both depict, the cantilever portion 304 extends from the helical portion to a terminus 306. The terminus 306 engages the spool valve 104, and more specifically is disposed within a cavity 148 (see FIGS. 1 and 2) formed in the spool valve 104.

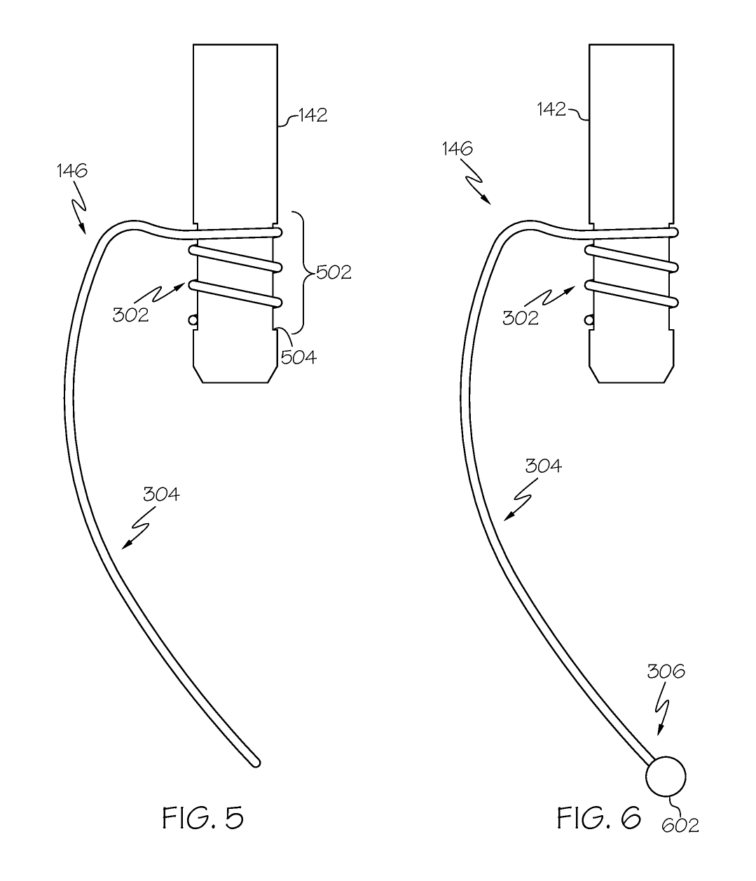

The feedback spring 146 may be disposed on the control mechanism 142 using any one of numerous techniques. In the embodiment depicted in FIG. 4, the feedback spring is interference fit onto the control mechanism 142, and is held in place via friction. In some embodiments, such as the one shown in FIG. 5, a recess 502 is machined into the control mechanism 142. The recess 502 defines an anti-slip ledge 504 that will at least inhibit movement of the feedback spring 146 off the control mechanism 142. In addition to the interference fit and/or machined recess 502, the feedback spring 142, at least in some embodiments, may be joined to the control mechanism 142 via, for example, a soldering process.

In the embodiment depicted in FIGS. 3-5, the terminus 306 does not include a cavity engagement feature. This may be but for relatively less critical, relatively low accuracy applications, such as non-aerospace applications. For relatively high accuracy applications, such as various aerospace applications, the feedback spring 146 may include such a feature.

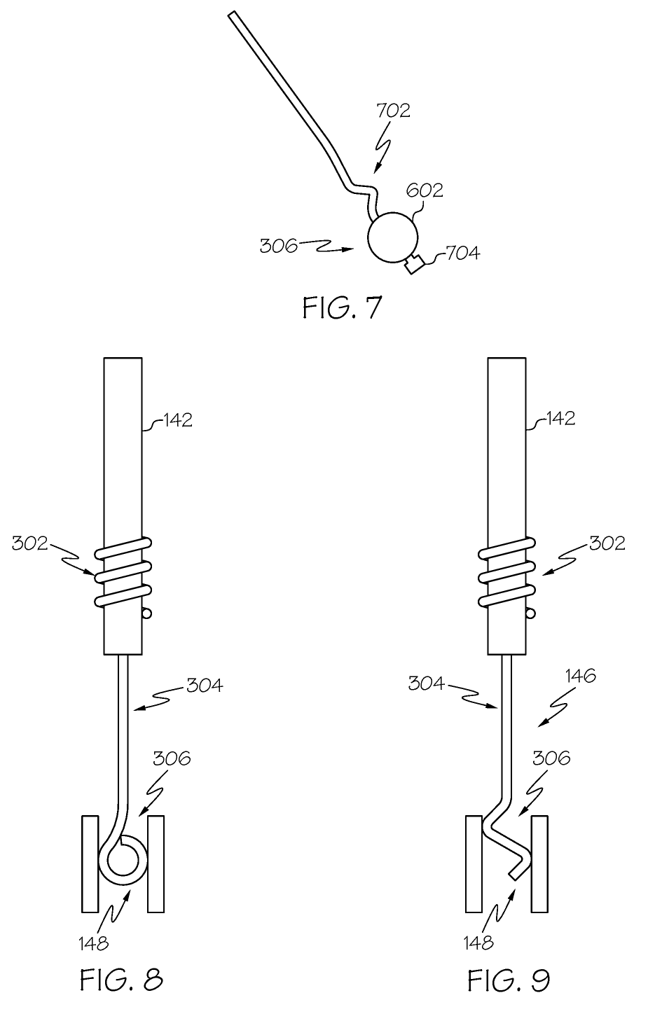

For example, as FIG. 6 depicts, the cavity engagement feature may include a spherical ball 602 disposed on the terminus 306. The spherical ball 602 may be formed as part of the terminus 306, or it may be separately made with a hole, then slid onto the terminus 306 and brazed in place. In other embodiments, such as the one depicted in FIG. 7, the terminus 306 may include a small bend 702 to prevent movement up the cantilever portion 304, and may be dead-headed 704 to prevent the spherical ball 602 from slipping off. The spherical ball 602, when included, may be made of carbide, sapphire, or any one of numerous other suitable materials.

In still other example embodiments, the cavity engagement feature may be implemented by forming the terminus 306 into a predetermined shape. Some non-limiting examples are depicted in FIGS. 8 and 9, where the terminus 306 is formed into a loop (FIG. 8) or into an S-shape (FIG. 9), and then disposed in the cavity 148 in the spool valve 104.

It will be appreciated that the feedback spring 146 may be made from any one of numerous known materials common to spring manufacturing. Some example materials include, but are not limited to, 17-7 PH Cond CH, music wire, and 301 stainless steel, just to name a few.

The spring rate of the feedback spring 146 may be varied, and differ from one EHSV design to another by changing various parameters. For example, the spring rate may be varied by changing the shape of the cantilever portion 304 between the helical coil 302 and the terminus 306, by changing the length, by changing the wire diameter, or by changing the materials. These parameters may also be varied to optimize the stiffness of the feedback spring 146.

It is additionally noted that the helical coil 302 may be implemented using either left-turn or right-turn types of coiling. Indeed, the difference in spring rate of these 2 types is negligible. On the order of about 0.02% with a one pound load applied to the terminus 306.

The feedback spring 146 described herein provides numerous advantages, some of which were wholly unexpected, over presently known feedback springs. For example, the number of parts is reduced from four (collar, disc, spring, ball) to only one. The assembly process is significantly simpler. Moreover, the cost-savings are significant, with the feedback spring 146 disclosed herein having a cost in the range of only about 5-10% of the cost of current feedback springs.

The spring rate of the feedback spring 146 was measured and unexpectedly found to be very linear. Fatigue testing on four different feedback springs 146 at displacements of 0.040-, 0.060-, 0.080-, and 0.100-inches was conducted. It should be noted that the typical maximum stroke is expected to be around 0.032-inches. Unexpectedly, all four feedback springs 146 passed 10 million cycles without issue. Although this fatigue test data is limited, infinite life is expected for the 0.040- and 0.060-inch strokes, and is likely for the 0.080-inch stroke. For comparison, when previous fatigue testing of presently known feedback springs was conducted, all of the springs failed before 500,000 cycles when stroked to 0.092 (6 springs) and 0.100 (2 springs) inches.

In one embodiment, an electrohydraulic servo valve (EHSV) includes a housing assembly, a spool valve, an armature, a control mechanism, and a feedback spring. The spool valve is movably disposed within the housing assembly. The armature is rotationally mounted on the housing assembly. The control mechanism is coupled to the armature and is rotatable therewith. The feedback spring is coupled between the control mechanism and the spool valve, and includes a helical coil that is disposed on and engages the control mechanism, and a cantilever portion that extends from the helical portion to a terminus that engages the spool valve.

These aspects and other embodiments may include one or more of the following features. The control mechanism comprises a flapper. The control mechanism comprises a jet tube. The feedback spring is interference fit onto the control mechanism. The feedback spring is joined to the control mechanism. A recess is machined into the control mechanism that defines an anti-slip ledge that at least inhibits movement of the feedback spring off the control mechanism. A cavity is formed in the spool valve, and a cavity engagement feature on the terminus of the cantilever portion is positioned within the cavity. The cavity engagement feature comprises a spherical ball disposed on the terminus. The cavity engagement feature comprises the terminus formed into a predetermined shape.

In another embodiment, an electrohydraulic servo valve (EHSV) includes a housing assembly, a spool valve, an armature, a jet tube, and a feedback spring. The spool valve is movably disposed within the housing assembly. The armature is rotationally mounted on the housing assembly. The jet tube is coupled to the armature and is rotatable therewith. The feedback spring is coupled between the jet tube and the spool valve, and includes a helical coil that is disposed on and engages the jet tube, and a cantilever portion that extends from the helical portion to a terminus that engages the spool valve.

These aspects and other embodiments may include one or more of the following features. The feedback spring is interference fit onto the jet tube. The feedback spring is joined to the jet tube. A recess is machined into the jet tube that defines an anti-slip ledge that at least inhibits movement of the feedback spring off the jet tube. A cavity is formed in the spool valve, and a cavity engagement feature on the terminus of the cantilever portion is positioned within the cavity.

In yet another embodiment, an electrohydraulic servo valve (EHSV) includes a housing assembly, a spool valve, an armature, a flapper, and a feedback spring. The spool valve is movably disposed within the housing assembly. The armature is rotationally mounted on the housing assembly. The flapper is coupled to the armature and is rotatable therewith. The feedback spring is coupled between the flapper and the spool valve, and includes a helical coil that is disposed on and engages the flapper, and a cantilever portion that extends from the helical portion to a terminus that engages the spool valve.

These aspects and other embodiments may include one or more of the following features. The feedback spring is interference fit onto the flapper. The feedback spring is joined to the flapper. A recess is machined into the flapper that defines an anti-slip ledge that at least inhibits movement of the feedback spring off the flapper. A cavity is formed in the spool valve, and a cavity engagement feature on the terminus of the cantilever portion is positioned within the cavity.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An electrohydraulic servo valve (EHSV), comprising:
a housing assembly;
a spool valve movably disposed within the housing assembly;
an armature rotationally mounted on the housing assembly;
a control mechanism coupled to the armature and rotatable therewith; and
a feedback spring coupled between the control mechanism and the spool valve, the feedback spring comprising:
a helical coil disposed on and engaging the control mechanism, and
a cantilever portion extending from the helical portion to a terminus, the terminus engaging the spool valve.

2. The EHSV of claim 1, wherein the control mechanism comprises a flapper.

3. The EHSV of claim 1, wherein the control mechanism comprises a jet tube.

4. The EHSV of claim 1, wherein:
the feedback spring is interference fit onto the control mechanism.

5. The EHSV of claim 4, wherein the feedback spring is joined to the control mechanism.

6. The EHSV of claim 4, further comprising:
a recess machined into the control mechanism, the recess defining an anti-slip ledge that at least inhibits movement of the feedback spring off the control mechanism.

7. The EHSV of claim 1, further comprising:
a cavity formed in the spool valve; and
a cavity engagement feature on the terminus of the cantilever portion, the cavity engagement feature positioned within the cavity.

8. The EHSV of claim 7, wherein the cavity engagement feature comprises a spherical ball disposed on the terminus.

9. The EHSV of claim 7, wherein the cavity engagement feature comprises the terminus formed into a predetermined shape.

10. An electrohydraulic servo valve (EHSV), comprising:
a housing assembly;
a spool valve movably disposed within the housing assembly;
an armature rotationally mounted on the housing assembly;
a jet tube coupled to the armature and rotatable therewith; and
a feedback spring coupled between the jet tube and the spool valve, the feedback spring comprising:
a helical coil disposed on and engaging the jet tube, and
a cantilever portion extending from the helical portion to a terminus, the terminus engaging the spool valve.

11. The EHSV of claim 10, wherein the feedback spring is interference fit onto the jet tube.

12. The EHSV of claim 11, wherein the feedback spring is joined to the jet tube.

13. The EHSV of claim 11, further comprising:
a recess machined into the jet tube, the recess defining an anti-slip ledge that at least inhibits movement of the feedback spring off the jet tube.

14. The EHSV of claim 10, further comprising:
a cavity formed in the spool valve; and
a cavity engagement feature on the terminus of the cantilever portion, the cavity engagement feature positioned within the cavity.

15. An electrohydraulic servo valve (EHSV), comprising:
a housing assembly;
a spool valve movably disposed within the housing assembly;
an armature rotationally mounted on the housing assembly;
a flapper coupled to the armature and rotatable therewith; and
a feedback spring coupled between the flapper and the spool valve, the feedback spring comprising:
a helical coil disposed on and engaging the flapper, and
a cantilever portion extending from the helical portion to a terminus, the terminus engaging the spool valve.

16. The EHSV of claim 15, wherein the feedback spring is interference fit onto the flapper.

17. The EHSV of claim 16, wherein the feedback spring is joined to the flapper.

18. The EHSV of claim 16, further comprising:
a recess machined into the flapper, the recess defining an anti-slip ledge that at least inhibits movement of the feedback spring off the flapper.

19. The EHSV of claim 15, further comprising:
a cavity formed in the spool valve; and
a cavity engagement feature on the terminus of the cantilever portion, the cavity engagement feature positioned within the cavity.
